(19) United States
(12) Patent Application Publication
(10) Pub. No.: US 2024/0162776 A1
(43) Pub. Date: May 16, 2024

(54) MOTOR

(71) Applicant: TOYOTA JIDOSHA KABUSHIKI KAISHA, Toyota-shi (JP)

(72) Inventors: Shogo KAJIMOTO, Toyota-shi (JP); Yukio TSUCHIYA, Toyota-shi (JP); Yasuhiro MAKIDO, Toyota-shi (JP); Hideyuki HIGASHI, Okazaki-shi (JP); Yuichiro KANADA, Toyota-shi (JP)

(73) Assignee: TOYOTA JIDOSHA KABUSHIKI KAISHA, Toyota-shi (JP)

(21) Appl. No.: 18/501,684

(22) Filed: Nov. 3, 2023

(30) Foreign Application Priority Data
Nov. 10, 2022 (JP) 2022-180236

(51) Int. Cl. H02K 5/20; H02K 1/20; H02K 5/10

(52) U.S. Cl. CPC H02K 5/20; H02K 1/20; H02K 5/10; H02K 2213/03

(57) ABSTRACT

A motor may include a rotor; a stator including a stator core and a coil; a housing that houses the rotor and the stator; and a first annular member that provides a seal between a first end face of the stator core in an axial direction of the stator core and an inner wall surface of the housing. The first annular member may be arranged so as to surround an outer periphery of a first coil end. The first annular member may include first holes through which refrigerant is injected toward the first coil end. At least one opening of the first holes may have a shape in which a maximum value of a first width, which is a dimension in a circumferential direction of the stator core, is greater than a maximum value of a second width, which is a dimension in the axial direction of the stator core.

### REFERENCE TO RELATED APPLICATIONS

This application claims priority from Japanese Patent Application No. 2022-180236 filed on Nov. 10, 2022. The entire content of the priority application is incorporated herein by reference.

### BACKGROUND ART

The technology disclosed herein relates to motors.

In a motor described in U.S. patent Ser. No. 11/125,315, a stator is housed in a housing. A plurality of injection holes is defined in an annular member that provides a seal between an axial end face of a stator core and an inner surface of the housing. Refrigerant is injected toward a coil end through each of the injection holes.

### DESCRIPTION

Refrigerant injected through a plurality of holes may be insufficient in amount. In this case, a coil end may not be sufficiently cooled, which may cause heat damage.

A motor may comprise a rotor; a stator comprising a stator core and a coil; a housing that houses the rotor and the stator; and a first annular member that provides a seal between a first end face of the stator core in an axial direction of the stator core and an inner wall surface of the housing. The first annular member may be arranged so as to surround an outer periphery of a first coil end of the coil protruding from the first end face of the stator core. The first annular member may comprise a plurality of first holes through which refrigerant is injected toward the first coil end. At least one opening of the plurality of first holes may have a shape in which a maximum value of a first width, which is a dimension in a circumferential direction of the stator core, is greater than a maximum value of a second width, which is a dimension in the axial direction of the stator core.

The refrigerant may comprise various types of refrigerants. For example, the refrigerant may be cooling oil. Alternatively, the refrigerant may be a liquid such as water or a gaseous fluid. According to the configuration above, regarding the at least one opening of the first holes, the maximum value of the first width, which is its dimension in the circumferential direction of the stator core, is greater than the maximum value of the second width, which is its dimension in the axial direction of the stator core. Thus, the at least one opening has an increased opening area as compared to a circular opening having the maximum value of the second width as its diameter. Since it is ensured that a sufficient amount of the refrigerant is injected from the first hole(s), the cooling performance for the coil end can be enhanced.

### BRIEF DESCRIPTION OF THE DRAWINGS

FIG. 1 is a schematic cross-sectional view of a motor 1.

FIG. 2 is a side view of a stator 20, etc.

FIG. 3 is a schematic cross-sectional view along a line in FIG. 1.

FIG. 4 is a partially enlarged view of a cross section along a line IV-IV in FIG. 2.

FIG. 5 is a schematic cross-sectional view along a line V-V lying on a center plane CP in FIG. 1.

FIG. 6 is a top view of a first hole H1.

FIG. 7 is a top view of a first hole H201.

FIG. 8 is a top view of a first hole H301.

FIG. 9 is a top view of a first hole H401.

FIG. 10 is a top view of a first hole H501.

FIG. 11 is a top view of a first hole H601.

The at least one opening may comprise a center portion including a center of the at last one opening in the circumferential direction, and a pair of end portions located opposite to each other in the circumferential direction with the center portion interposed therebetween. In each of the pair of end portions, the second width may decrease from an end of the end portion closer to the center portion toward another end of the end portion farther from the center portion.

In the configuration above, in each end portion, the area of the at least one opening is larger at its portions closer to the center of the at least one opening in the circumferential direction.

The maximum value of the second width may be a value at the center of the at least one opening in the circumferential direction.

The configuration above allows for an increase in an injection amount from the center of at least one first hole in the circumferential direction.

In the center portion, the second width may decrease from the center toward ends of the center portion in the circumferential direction.

The configuration above allows for an appropriate increase in an injection amount from the center of at least one first hole in the circumferential direction.

The at least one opening may be elliptical in shape.

In the configuration above, the edge of the at least one opening is formed by a smoothly curved line. This appropriately suppresses an uneven injection amount distribution in the at least one first hole.

In the center portion, the second width may be constant in the circumferential direction.

In the configuration above, an injection amount of the refrigerant from the center portion is substantially constant in the circumferential direction. This allows the first coil end to be evenly cooled in the circumferential direction.

The at least one opening may be oval in shape.

In the configuration above, the edges of the end portions are each formed by a smoothly curved line. This appropriately suppresses an uneven injection amount distribution in the at least one first hole.

In the center portion, the second width may increase from the center toward ends of the center portion in the circumferential direction.

In the configuration above, the refrigerant is injected in a larger amount from parts of the center portion that are close to the end portions. This allows the first coil end to be cooled over a broad area in the circumferential direction.

The at least one opening may have a polygonal shape with each corner rounded.

The maximum value of the first width may be at least 1.5 times the maximum value of the second width.

In the configuration above, the refrigerant injection distribution is appropriately broadened in the circumferential direction rather than in the axial direction.

The housing may comprise a supply port through which the refrigerant is supplied from outside. A flow path may be defined in an outer circumferential surface of the stator core, and the flow path may allow the refrigerant supplied through the supply port to flow toward the first annular member.

This configuration allows the stator to be appropriately cooled by flowing the refrigerant in the flow path.

The flow path may comprise a plurality of channels extending in the axial direction. The maximum value of the first width may be greater than or equal to a width of the plurality of channels in the circumferential direction.

This configuration allows to appropriately introduce the refrigerant flowing in the channels into the first holes.

The motor may further comprise a second annular member that provides a seal between a second end face of the stator core and the inner wall surface of the housing, the second end face being opposite to the first end face of the stator core in the axial direction. The second annular member may be arranged so as to surround an outer periphery of a second coil end of the coil protruding from the second end face of the stator core. The second annular member may comprise a plurality of second holes through which the refrigerant is injected toward the second coil end. At least one opening of the plurality of second holes may have a shape in which a maximum value of a first width, which is a dimension in a circumferential direction of the stator core, is greater than a maximum value of a second width, which is a dimension in the axial direction of the stator core.

This configuration allows both the first and second coil ends to be appropriately cooled.

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved motors.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### EMBODIMENTS

### First Embodiment

Configuration of Motor 1

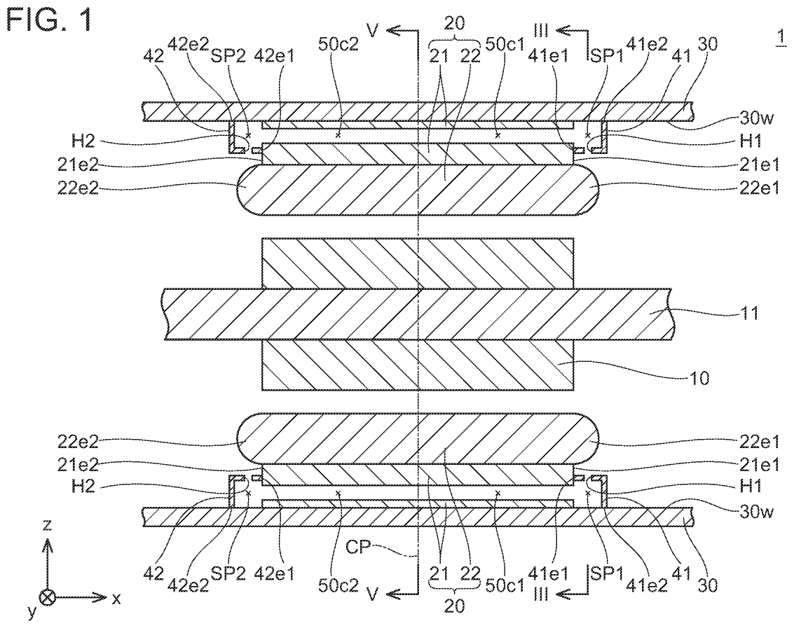

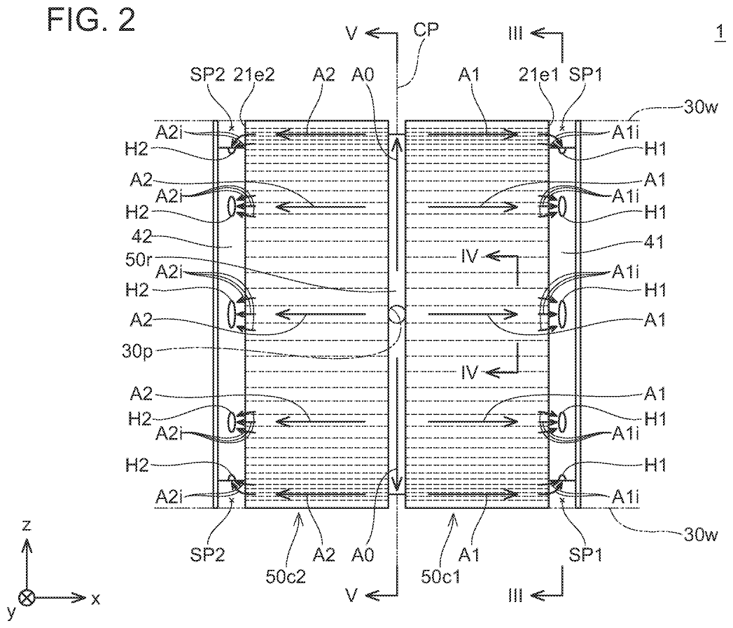

FIG. 1 shows a schematic cross-sectional view of a motor 1 according to an embodiment. FIG. 2 shows a side view of a stator 20, a first annular member 41, and a second annular member 42. In FIG. 2, depictions of a housing 30, a rotor 10, and a rotation shaft 11 are omitted for the sake of clarity, and an inner wall surface 30w and a supply port 30p of the housing 30 are represented by imaginary lines. In FIGS. 1 and 2, z-direction is a vertical direction, and x-direction and y-direction are horizontal directions. The x-direction is a direction in which the rotation shaft 11 extends. These directions also apply to the other drawings.

The motor 1 is mounted on an electric-powered vehicle. The electric-powered vehicle comprises a hybrid vehicle and an electric vehicle. In the electric-powered vehicle, the motor 1 may be used as a traction motor that generates power for the vehicle to travel, or as a generator that generates electric power from regenerative braking power and/or excess power of an engine. In the electric-powered vehicle, the motor 1 is mounted such that −z-direction is coincident with the gravity direction.

As shown in FIG. 1, the motor 1 comprises a center plane CP perpendicular to the rotation shaft 11. The center plane CP passes the center of a stator core 21 in its axial direction. The structure of the motor 1 is symmetric with respect to the center plane CP. Thus, hereinafter, the structure on +x-direction side relative to the center plane CP is mainly described.

The motor 1 mainly comprises the rotor 10, the stator 20, the housing 30, the first annular member 41, and the second annular member 42. The rotor 10 comprises the rotation shaft 11. The rotation shaft 11 is supported by the housing 30 via a bearing (not shown) and is rotatable. The rotor 10 is fixed to the rotation shaft 11.

The stator 20 comprises the stator core 21 and a coil 22. The stator core 21 is a substantially annular member formed, for example, of a stack of steel plates. The stator core 21 includes a first end face 21e1 at its one end in the axial direction (x-direction) and a second end face 21e2 at its other end in the axial direction. A wire that constitutes the coil 22 is wound around the stator core 21. A first coil end 22e1 of the coil 22 protrudes in the axial direction from the first end face 21e1. A second coil end 22e2 of the coil 22 protrudes in the axial direction from the second end face 21e2.

The housing 30 is a member that houses the rotor 10 and the stator 20. The housing 30 surrounds the stator 20. A supply hole 30p, which will be described later, is defined in a side surface of the housing 30. A cooling oil reservoir (not shown) is disposed at a bottom portion of the housing 30. Known prior art can be applied for basic configuration of the housing 30, and thus its detailed description is omitted here.

The first annular member 41 has a ring shape about the rotation shaft 11. The first annular member 41 is constituted of resin. As shown in FIG. 1, a first end portion 41e1 of the first annular member 41 is connected to the first end face 21e1 of the stator core 21. A second end portion 41e2 of the first annular member 41 is connected to an inner wall surface 30w of the housing 30. In this way, the first annular member 41 provides a seal between the first end face 21e1 and the inner wall surface 30w. A variety of features that enhance the sealability (e.g., seal groove) may be applied to the connection between the first end portion 41e1 and the first end face 21e1 and between the second end portion 41e2 and the inner wall surface 30w. A space SP1 is defined between the first annular member 41 and the inner wall surface 30w. The space SP1 has a ring shape about the rotation shaft 11. The first annular member 41 surrounds the first coil end 22e1. In other words, the first annular member 41 faces the first coil end 22e1.

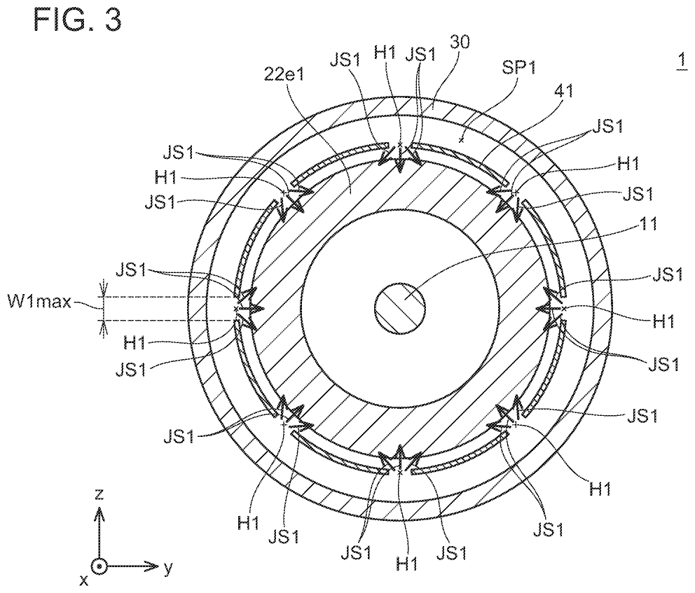

The first annular member 41 comprises a plurality of first holes H1. Cooling oil is injected toward the first coil end 22e1 through the first holes H1. Referring to FIG. 3, the plurality of first holes H1 is described. FIG. 3 shows a schematic cross-sectional view along a line in FIG. 1. FIG. 3 shows a cross-sectional view passing the centers of the first holes H1. The plurality of first holes H1 penetrates the first annular member 41 in its thickness direction. As shown in FIG. 3, the first holes H1 are equally spaced apart from each other on a circumference. In the present embodiment, there are eight first holes H1.

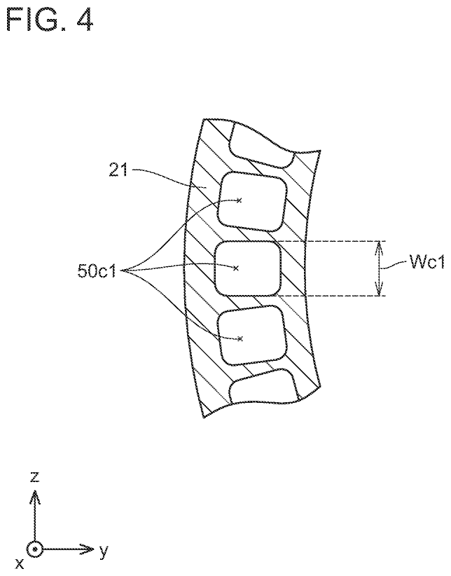

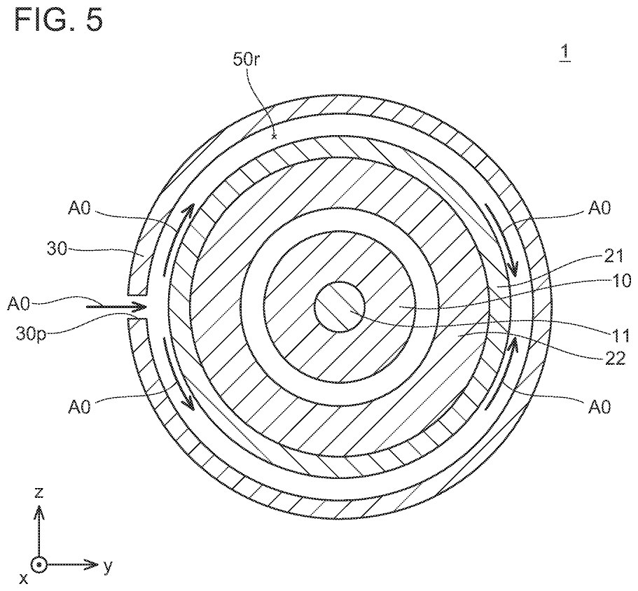

Referring to FIGS. 1, 2, 4, and 5, the stator core 21 is described. FIG. 4 shows a partially enlarged view of a cross section along a line IV-IV in FIG. 2. FIG. 5 shows a schematic cross-sectional view along a line V-V lying on the center plane CP in FIG. 1. The stator core 21 is a cylindrical member. As shown in FIG. 2, the stator core 21 comprises an annular channel 50r, first channels 50c1, and second channels 50c2.

As shown in FIG. 5, the annular channel 50r is a groove defined in the stator core 21 to extend over the entire circumference thereof. The annular channel 50r is open upward. This opening is covered by the inner wall surface 30w, which defines a flow path. The annular channel 50r is in communication with the supply port 30p of the housing 30.

As shown in FIGS. 2 and 4, the first channels 50c1 are tunnel-shaped flow paths defined in an outer circumferential surface of the stator core 21. In FIG. 2, the plurality of first channels 50c1 and the plurality of second channels 50c2 are represented by broken lines. The plurality of first channels 50c1 extends from the annular channel 50r up to the first end face 21e1, which is oriented in +x-direction. The first channels 50c1 extend parallel to each other and are equally spaced apart from each other in the circumferential direction. The plurality of second channels 50c2 has the same configuration as that of the plurality of first channels 50c1. The plurality of second channels 50c2 extends from the annular channel 50r up to the second end face 21e2, which is oriented in −x-direction.

Shape of First Holes H1

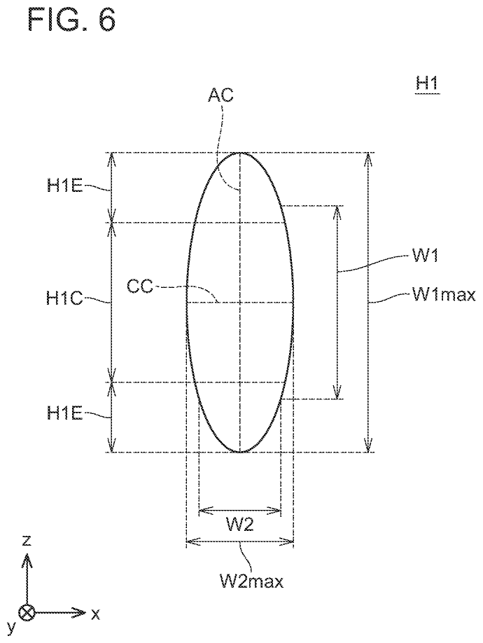

Openings of the first holes H1 have the same shape. Therefore, the following description focuses on the shape of an opening of one of the first holes H1. FIG. 6 shows a top view of a first hole H1. The first hole H1 shown in FIG. 6 is a hole that is located in the middle in the vertical direction in FIG. 2. X-direction is the axial direction of the stator core 21. Z-direction is the circumferential direction of the stator core 21.

The opening of the first hole H1 is elliptical in shape. The shape is detailed as follows. The opening of the first hole H1 comprises a first width W1 which is a dimension in the circumferential direction and a second width W2 which is a dimension in the axial direction. The opening of the first hole H1 comprises a circumferential center CC, which is the center of the opening in the circumferential direction, and an axial center AC, which is the center of the opening in the axial direction. Further, the opening of the first hole H1 comprises a center portion H1C and end portions H1E. The center portion H1C includes the circumferential center CC. The end portions HE are a pair of portions opposite to each other in the circumferential direction with the center portion H1C interposed therebetween.

At the axial center AC, the first width W1 is a first maximum width W1max, which is the maximum value of the first width W1. The first width W1 gradually decreases from the axial center AC toward the respective ends of the opening in the axial direction (toward the right and left on the drawing sheet). At the circumferential center CC, the second width W2 is a second maximum width W2max, which is the maximum value of the second width W2. In the center portion H1C, the second width W2 gradually decreases from the circumferential center CC toward the respective ends of the center portion H1C in the circumferential direction (toward the upside and downside on the drawing sheet). The edges of the center portion H1C of the opening are formed by curved lines. In each of the pair of end portions H1E, the second width W2 gradually decreases from an end of the end portion HE closer to the circumferential center CC toward another end of the end portion HE farther from the circumferential center CC. The edge of each end portion HE is formed by a curved line.

The first maximum width W1max is greater than the second maximum width W2max. In the present embodiment, the first maximum width W1max is at least 1.5 times the second maximum width W2max. As shown in FIG. 4, each first channels 50c1 comprises a channel width Wc1 in the circumferential direction. The first maximum width W1max is greater than or equal to the channel width Wc1.

The structure on +x-direction side relative to the center plane CP has been mainly described above. The structure on −x-direction side relative to the center plane CP is similar to that on +x-direction side. That is, there is a second annular member 42 that provides a seal between the second end face 21e2 of the stator core 21 and the inner wall surface 30w of the housing 30. A space SP2 is defined between the second annular member 42 and the inner wall surface 30w. The second annular member 42 comprises a plurality of second holes H2. The cooling oil is injected toward the second coil end 22e2 through the plurality of second holes H2. Openings of the second holes H2 have the same elliptical shape. In each opening, a first maximum width W1max in the circumferential direction is greater than a second maximum width W2max in the axial direction. Further description on the structure on −x-direction side relative to the center plane CP is omitted herein.

Operation

How the motor 1 operates is described. The cooling oil in the cooling oil reservoir flows through a pump and a supply pipe, which are not shown, and then flows into the supply port 30p of the housing 30. The cooling oil supplied through the supply port 30p flows into the annular channel 50r. This cooling oil flows within the annular channel 50r in the circumferential direction (see arrows A0 in FIGS. 2 and 5). Then, the cooling oil flows into each of the plurality of first channels 50c1 and flows in +x-direction (see arrows A1 in FIG. 2).

Once reaching +x direction ends of the first channels 50c1, the cooling oil is discharged to the space SP1 and reaches the first annular member 41. A part of the discharged cooling oil directly flows into each of the first holes H1 (see arrows Ali). The rest of the discharged cooling oil flows into each of the first holes H1 via the space SP1. As described above, the first maximum width W1max (FIG. 6) of the openings of the first holes H1 is greater than or equal to the channel width Wc1 (FIG. 4) of the first channels 50c1. This allows the cooling oil discharged from the first channels 50c1 to easily flow into the first holes H1.

Referring to FIG. 3, how the cooling oil is injected is described. As shown in FIG. 3, the cooling oil is injected from each of the first holes H1 toward the first coil end 22e1. In FIG. 3, the injected cooling oil is represented by vectors JS1. As described above, in the opening of each first hole H1, the diameter in the circumferential direction is greater than the diameter in the axial direction. Therefore, as shown by the vectors JS1, the cooling oil can be injected to spread in the circumferential direction.

Effects

The opening of each first hole H1 has an elliptical shape in which the first maximum width W1max in the circumferential direction is greater than the second maximum width W2max in the axial direction. Thus, the opening of each first hole H1 has an increased area as compared to a circular opening having a diameter of the second maximum width W2max. Thus, the cooling oil, which has reached the first annular member 41, can sufficiently flow into the plurality of first holes H1 (see arrows Ali in FIG. 2). Since it is ensured that a sufficient amount of the cooling oil is injected from the plurality of first holes H1, the cooling performance for the first coil end 22e1 is enhanced.

As shown in FIG. 6, the second width W2 can be the second maximum width W2max at the circumferential center CC. In the center portion H1C, the second width W2 gradually decreases from the circumferential center CC toward the respective ends of the center portion H1C close to the end portions HE (toward the upside and downside on the drawing sheet). This allows the cooling oil to be injected in a larger amount from the circumferential center CC at which loss is smaller, as compared to injection amounts from the other portions at which loss is large. Therefore, the total amount of cooling oil injected from the plurality of first holes H1 can be appropriately increased.

If the edge of the opening of a first hole H1 includes one or more corners formed by straight lines, the injection amount may be varied at the one or more corners, which may cause an uneven injection amount distribution. In the technology according to the present embodiment, the openings of the first holes H1 have an elliptical shape, and thus the edges of the openings do not include any straight-line portion and are formed by smoothly curved lines. Therefore, the uneven injection amount distribution can be appropriately suppressed in each first hole H1.

### Second Embodiment

Configuration of First Holes H201

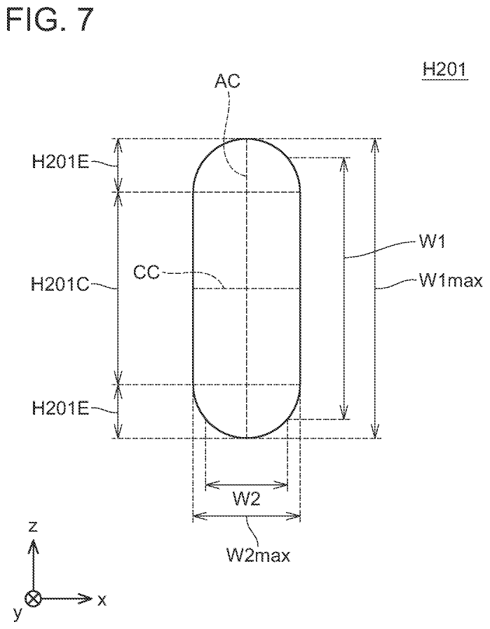

A second embodiment is different from the first embodiment in the shape of a plurality of first holes H201. Configurations same as those described in connection with the first embodiment are labeled with the same reference signs, and description for them is omitted. FIG. 7 shows a top view of a first hole H201 according to the second embodiment. The first hole H201 shown in FIG. 7 is located at the same position as the first hole according to the first embodiment shown in FIG. 6.

The opening of the first hole H201 is oval in shape. The shape is detailed as follows. A first width W1 which is a dimension in the circumferential direction (in up-down direction on the drawing sheet) can be a first maximum width W1max, which is the maximum value of the first width W1, at the axial center AC. A second width W2 which is a dimension in the axial direction (in right-left direction on the drawing sheet) can be a second maximum width W2max, which is the maximum value of the second width W2, at the circumferential center CC. In the present embodiment, the first maximum width W1max is at least 1.5 times the second maximum width W2max.

In a center portion H201C, the second width W2 is constant in the circumferential direction. Thus, the edge of the center portion H201C is formed by straight lines parallel to each other. In each of a pair of end portions H201E, the second width W2 gradually decreases from an end of the end portion H201E closer to the circumferential center CC toward another end thereof farther from the circumferential center CC. The edge of each end portion H201E is formed by a curved line.

Effects

In the technology according to the present embodiment, the injection amount of cooling oil from the center portion H201C is substantially constant in the circumferential direction. This allows the first coil end 22e1 to be evenly cooled in the circumferential direction.

In the technology according to the present embodiment, the edges of the end portions H201E are formed by smoothly curved lines. This allows to appropriately suppress an uneven injection amount distribution in each of the end portions H201E.

### Third Embodiment

Configuration of First Holes H301

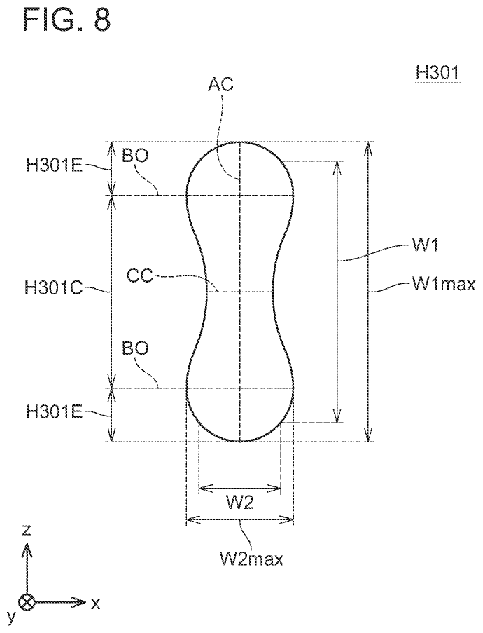

A third embodiment is different from the first and second embodiments in the shape of a plurality of first holes H301. Configurations same as those described in connection with the first embodiment are labeled with the same reference signs, and description for them is omitted. FIG. 8 shows a top view of a first hole H301 according to the third embodiment. The first hole H301 shown in FIG. 8 is located at the same position as the first hole according to the first embodiment shown in FIG. 6.

The opening of the first hole H301 has an hourglass shape in which a second width W2 is narrowed near the circumferential center CC. The shape is detailed as follows. A first width W1 which is a dimension in the circumferential direction (in up-down direction on the drawing sheet) can be a first maximum width W1max, which is the maximum value of the first width W1, at the axial center AC. The second width W2 which is a dimension in the axial direction (in right-left direction on the drawing sheet) can be a second maximum width W2max, which is the maximum value of the second width W2, at borders BO between a center portion H301C and respective end portions H301E. In the present embodiment, the first maximum width W1max is at least 1.5 times the second maximum width W2max.

In the center portion H301C, the second width W2 gradually increases from the circumferential center CC toward ends of the center portion H301C in the circumferential direction (toward the upside and downside on the drawing sheet). The edge of the center portion H301C is formed by curved lines. In each of the pair of end portions H301E, the second width W2 gradually decreases from an end of the end portion H301E closer to the circumferential center CC toward another end thereof farther from the circumferential center CC. The edge of each end portion H301E is formed by a curved line.

Effects

In the technology according to the present embodiment, the injection amount from the pair of end portions H301E is relatively increased by narrowing the second width W2 near the circumferential center CC. This allows the first coil end 22e1 to be cooled over a broad area in the circumferential direction.

### Fourth Embodiment

Configurations of First Holes H401, H501, and H601

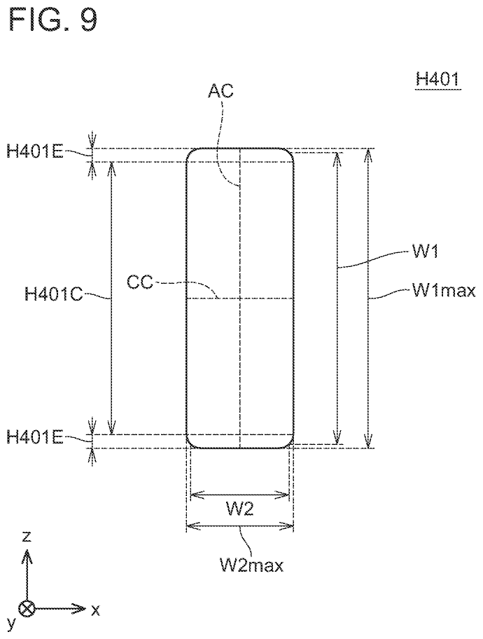

A fourth embodiment is different from the first to third embodiments in the shapes of a plurality of first holes H401, H501, and H601. Configurations same as those described in connection with the first embodiment are labeled with the same reference signs, and description for them is omitted. FIGS. 9, 10, and 11 show top views of a first hole H401, a first hole H501, and a first hole H601 according to the fourth embodiment, respectively. The first holes H401, H501, and H601 shown in FIGS. 9, 10, and 11 are located at the same position as the first hole according to the first embodiment shown in FIG. 6.

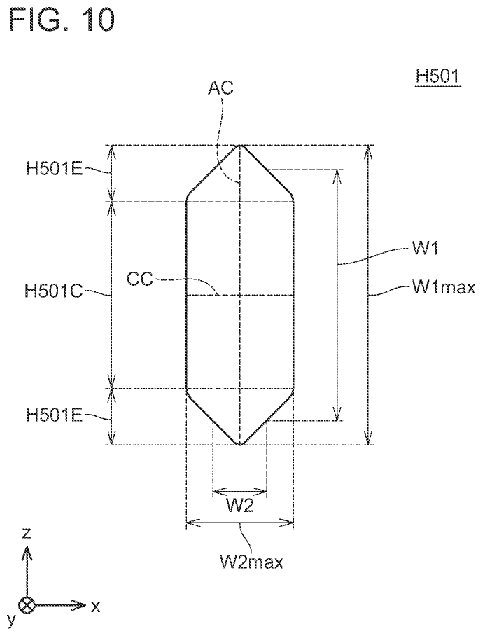

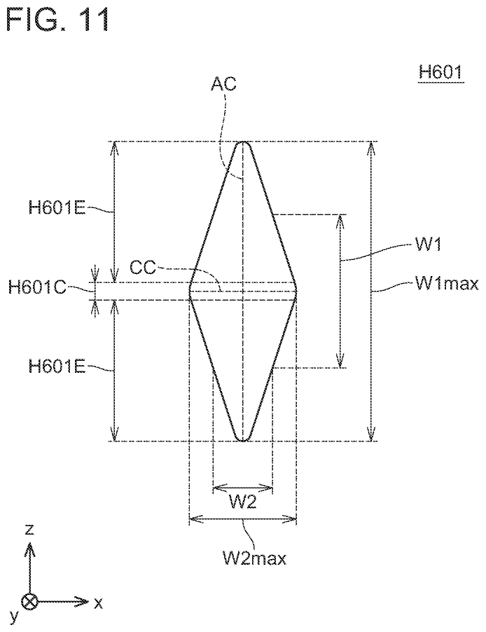

The openings of the first holes H401, H501, and H601 have polygonal shapes with each corner rounded. The opening of the first hole H401 shown in FIG. 9 has a rectangular shape. The opening of the first hole H501 shown in FIG. 10 includes a rectangular center portion H501C and a pair of triangular end portions H1E. The opening of the first hole H601 shown in FIG. 11 has a rhombic shape.

The following description is common to the first holes H401, H501, and H601. A first width W1 which is a dimension in the circumferential direction (in up-down direction on the drawing sheets) can be a first maximum width W1max, which is the maximum value of the first width W1, at the axial center AC. A second width W2 which is a dimension in the axial direction (in right-left direction on the drawing sheets) can be a second maximum width W2max, which is the maximum value of the second width W2, at the circumferential center CC. In the present embodiment, the first maximum width W1max is at least 1.5 times the second maximum width W2max. In a center portion H401C (FIG. 9) and a center portion H501C (FIG. 10), the second width W2 is constant in the circumferential direction. Thus, the edges of the center portions H401C and H501C are each formed by straight lines parallel to each other. In each of end portions H401E (FIG. 9), H501E (FIG. 10), and H601E (FIG. 11), the second width W2 gradually decreases from an end of the end portion closer to the circumferential center CC toward another end thereof farther from the circumferential center CC.

Effects

Even with polygonal shaped openings such as the ones according to the present embodiment, it is ensured that a sufficient amount of cooling oil flows into the first holes. Further, the cooling oil can be injected to spread in the circumferential direction.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

Modification

The shapes of the openings of the first and second holes are not limited to those described herein but may be various other shapes. Further, the number and arrangement of the first and second holes are not limited to those described herein but may be different.

What is claimed is:

1. A motor comprising:
a rotor;
a stator comprising a stator core and a coil;
a housing that houses the rotor and the stator; and
a first annular member that provides a seal between a first end face of the stator core in an axial direction of the stator core and an inner wall surface of the housing,
wherein
the first annular member is arranged so as to surround an outer periphery of a first coil end of the coil protruding from the first end face of the stator core,
the first annular member comprises a plurality of first holes through which refrigerant is injected toward the first coil end, and
at least one opening of the plurality of first holes has a shape in which a maximum value of a first width, which is a dimension in a circumferential direction of the stator core, is greater than a maximum value of a second width, which is a dimension in the axial direction of the stator core.

2. The motor according to claim 1, wherein
the at least one opening comprises a center portion including a center of the at least one opening in the circumferential direction, and a pair of end portions located opposite to each other in the circumferential direction with the center portion interposed therebetween, and
in each of the pair of end portions, the second width decreases from an end of the end portion closer to the center portion toward another end of the end portion farther from the center portion.

3. The motor according to claim 2, wherein the maximum value of the second width is a value at the center of the at least one opening in the circumferential direction.

4. The motor according to claim 3, wherein in the center portion, the second width decreases from the center toward ends of the center portion in the circumferential direction.

5. The motor according to claim 4, wherein the at least one opening is elliptical in shape.

6. The motor according to claim 3, wherein in the center portion, the second width is constant in the circumferential direction.

7. The motor according to claim 6, wherein the at least one opening is oval in shape.

8. The motor according to claim 2, wherein in the center portion, the second width increases from the center toward ends of the center portion in the circumferential direction.

9. The motor according to claim 1, wherein the at least one opening has a polygonal shape with each corner rounded.

10. The motor according to claim 1, wherein the maximum value of the first width is at least 1.5 times the maximum value of the second width.

11. The motor according to claim 1, wherein
the housing comprises a supply port through which the refrigerant is supplied from outside, and
a flow path is defined in an outer circumferential surface of the stator core, and the flow path allowing the refrigerant supplied through the supply port to flow toward the first annular member.

12. The motor according to claim 11, wherein
the flow path comprises a plurality of channels extending in the axial direction, and
the maximum value of the first width is greater than or equal to a width of the plurality of channels in the circumferential direction.

13. The motor according to claim 1, wherein
the motor further comprises a second annular member that provides a seal between a second end face of the stator core and the inner wall surface of the housing, the second end face being opposite to the first end face of the stator core in the axial direction,
the second annular member is arranged so as to surround an outer periphery of a second coil end of the coil protruding from the second end face of the stator core,
the second annular member comprises a plurality of second holes through which the refrigerant is injected toward the second coil end, and
at least one opening of the plurality of second holes has a shape in which a maximum value of a first width, which is a dimension in a circumferential direction of the stator core, is greater than a maximum value of a second width, which is a dimension in the axial direction of the stator core.
